(19) United States
(12) Patent Application Publication
(10) Pub. No.: US 2019/0272063 A1
(43) Pub. Date: Sep. 5, 2019

(54) TOUCH PANEL AND TOUCH PANEL DEVICE USING SAME

(71) Applicant: Panasonic Intellectual Property Management Co., Ltd., Osaka (JP)

(72) Inventors: HIROMITSU NIWA, Osaka (JP); KENJI SHIBATA, Osaka (JP)

(21) Appl. No.: 16/333,723

(22) PCT Filed: Oct. 5, 2017
(86) PCT No.: PCT/JP2017/036294

§ 371 Date: Mar. 15, 2019

(30) Foreign Application Priority Data
Oct. 18, 2016 (JP) 2016-204308

(51) Int. Cl. G06F 3/044; G06F 3/047; G06F 3/041

(52) U.S. Cl. CPC G06F 3/0443; G06F 3/0416; G06F 3/047

(57) ABSTRACT

A touch panel includes transmission electrodes arranged in a first direction, and wirings each connected to respective one of the transmission electrodes. The transmission electrodes have strip shapes slenderly extending in a second direction crossing the first direction. The transmission electrodes include first and second transmission electrodes adjacent to each other in the first direction. The wirings include first and second wirings connected to the first and second transmission electrodes, respectively. One end of the first transmission electrode is connected to the first wiring. Another end of the first transmission electrode is an open end. One end of the second transmission electrode is connected to the second wiring. Another end of the second transmission electrode is an open end. The first and transmission electrodes are driven simultaneously by first and second signals input through the first and second wirings, respectively. The touch panel is preferable in detection accuracy.

### TECHNICAL FIELD

The present invention relates to a touch panel used for various electronic devices.

### BACKGROUND ART

An electronic device includes an input operation unit equipped with a capacitive type of touch panel mounted in front of an indicator. An operator visually recognizes items on the indicator through a transparent touch panel. The operator touches the touch panel with, e.g. a finger thereof, and selects a predetermined function of the electronic device to operate it.

The touch panel of a capacitive type disclosed in PTL 1 includes transmission electrodes and receiving electrodes with strip shapes arranged in directions crossing each other. In the touch panel, the transmission electrodes are driven one by one sequentially while each receiving electrode receives electric field from respective one of the transmission electrodes. The capacitance between each receiving electrodes and respective one of the transmission electrodes changes according to intensity of the received electric field. Based on the change in capacitance, the touch panel detects a position touched with the finger.

### CITATION LIST

### Patent Literature

PTL 1: Japanese Patent Laid-Open Publication No. 2014-81870

### SUMMARY

A touch panel includes transmission electrodes arranged in a first direction, and wirings each connected to respective one of the transmission electrodes. The transmission electrodes have strip shapes slenderly extending in a second direction crossing the first direction. The transmission electrodes include first and second transmission electrodes adjacent to each other in the first direction. The wirings include first and second wirings connected to the first and second transmission electrodes, respectively. The first transmission electrode has one end and another end to extend slenderly from the one end thereof to another end thereof in the second direction. The one end of the first transmission electrode is connected to the first wiring. Another end of the first transmission electrode is an open end. The second transmission electrode has one end and another end to extend slenderly from the one end thereof to another end thereof in a direction opposite to the second direction. The one end of the second transmission electrode is connected to the second wiring. Another end of the second transmission electrode is an open end. The first and transmission electrodes are driven simultaneously by first and second signals input through the first and second wirings, respectively.

The touch panel is preferable in detection accuracy.

### BRIEF DESCRIPTION OF DRAWINGS

FIG. 1A is a top view of a touch panel in accordance with an exemplary embodiment.

FIG. 1B is a schematic cross-sectional view of the touch panel along line 1B-1B shown in FIG. 1A.

FIG. 2 is a plan view of the touch panel in accordance with the embodiment for schematically illustrating transmission electrodes of the touch panel.

FIG. 3 is a plan view of the touch panel in accordance with the embodiment for schematically illustrating receiving electrodes of the touch panel.

FIG. 4 is a block diagram of a touch panel device in accordance with the embodiment.

FIG. 5 shows a capacitance value between a transmission electrode and a receiving electrode of the touch panel in accordance with the embodiment.

FIG. 6 shows a capacitance value between each of the transmission electrodes and respective one of the receiving electrodes of the touch panel in accordance with the embodiment.

FIG. 7 shows a capacitance value between a transmission electrode and a receiving electrode of a comparative example of a touch panel in operation.

FIG. 8 shows a capacitance value between a transmission electrode and a receiving electrode of the comparative example of the touch panel in operation.

FIG. 9 shows a capacitance value between each of transmission electrodes and respective one of receiving electrodes of the comparative example of the touch panel in operation.

FIG. 10 is a plan view of the touch panel in accordance with the exemplary embodiment for illustrating another operation of the touch panel.

### DETAIL DESCRIPTION OF PREFERRED EMBODIMENT

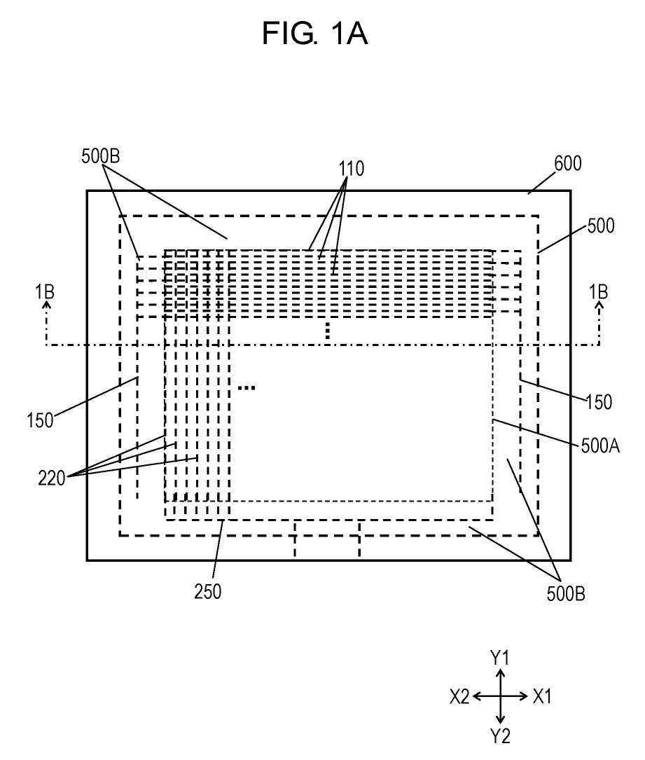

FIG. 1A is a top view of touch panel 500 in accordance with an exemplary embodiment. FIG. 1B is a schematic cross-sectional view of touch panel 500 along line 1B-1B shown in FIG. 1A. Touch panel 500 includes substrate 100, transmission electrodes 110, wirings 150 connected to transmission electrodes 110, substrate 200, receiving electrodes 220, and wirings 250 connected to receiving electrodes 220. Substrates 100 and 200 have transparency. Substrates 100 and 200 are made of transparent materials, such as glass or a resin sheet of, e.g. PET. Substrates 100 and 200 have, e.g. rectangular shape. Touch panel 500 is configured to detect a position on detection area 500A touched with an object, such as a finger.

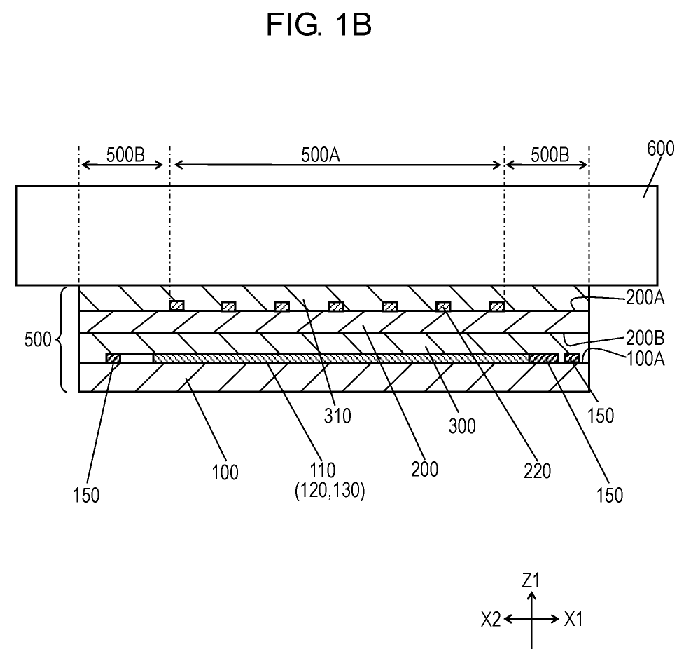

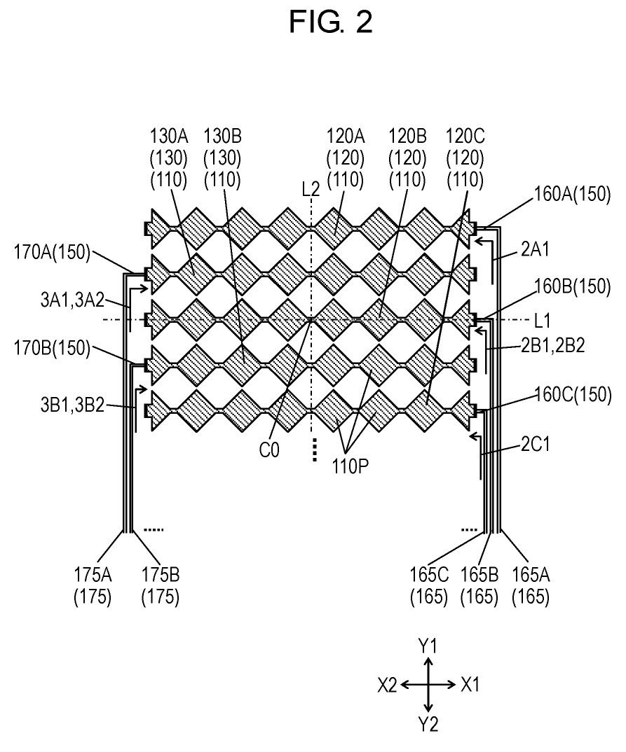

FIG. 2 is a plan view of the touch panel for schematically illustrating transmission electrodes 110. FIG. 3 is a plan view of the touch panel for schematically illustrating receiving electrodes 220. Transmission electrodes 110 with strip shapes are provided on upper surface 100A of substrate 100. Receiving electrodes 220 with strip shapes are provided on upper surface 200A of substrate 200. Transmission electrodes 110 and receiving electrodes 220 have transparency. Transmission electrodes 110 and receiving electrodes 220 are made of transparent and conductive materials, such as ITO or transparent and conductive resin. Transmission electrodes 110 and receiving electrodes 220 may be made of thin metal wirings made of conductive metals, such as copper or silver, and arranged along a mesh pattern. The thin metal wirings have line widths of several micrometers. Transmission electrodes 110 are arranged in direction Y1 when viewed from above the touch panel. Receiving electrodes 220 are arranged in direction X1 crossing direction Y1. In accordance with the embodiment, direction X1 crosses direction Y1 perpendicularly, but not limited to it. Direction X1 may not necessarily cross direction Y1 perpendicularly, as long as crossing direction Y1. Receiving electrodes 220 face transmission electrodes 110 in direction Z1 crossing directions Y1 and X1 such that receiving electrodes 220 are spaced from transmission electrodes 110. As shown in FIG. 1A, transmission electrodes 110 and receiving electrodes 220 are located in detection area 500A when viewed from above the touch panel.

As shown in FIG. 1B, upper surface 100A of substrate 100 is bonded to lower surface 200B of substrate 200 with transparent adhesive layer 300 such that upper surface 100A and upper surface 200A are directed to the same direction. Transmission electrodes 110 are provided on upper surface 100A. Receiving electrodes 220 are provided on upper surface 200A. In other words, substrate 100 and substrate 200 are unitarily stacked. Transparent adhesive layer 310 is provided on upper surface 200A of substrate 200 opposite to a surface of substrate 200 on which substrate 100 is disposed. Touch panel 500 is mounted to an electronic device such that touch panel 500 is bonded to cover lens 600 with adhesive layer 310.

Transmission electrodes 110 and wirings 150 will be described below with reference to FIG. 2.

As shown in FIG. 2, transmission electrodes 110 are arranged in direction Y1 at predetermined pitches. In accordance with the embodiment, the pitches are constant. Transmission electrodes 110 are parallel to one another, and have strip shapes extending slenderly and linearly in direction X1. Transmission electrodes 110 are made of materials identical to each other and have shapes substantially identical to each other. In detail, transmission electrodes 110 have shapes identical to each other such that any one transmission electrode among transmission electrodes 110 substantially completely overlaps another transmission electrode among transmission electrodes 110 when the any one transmission electrode is translated.

Transmission electrodes 110 include transmission electrode 120 (120A, 120B, . . . ) and transmission electrode 130 (130A, 130B, . . . ). Wirings 150 include wiring 160 (160A, 160B, . . . ) and wiring 170 (170A, 170B, . . . ). Wiring 160 among wirings 150 is connected to an end of transmission electrode 120 in direction X1. An end of transmission electrode 120 in direction X2 opposite to direction X1 is opened. Terminal 165 is provided at an end of wiring 160 opposite to the end of wiring 170 connected to transmission electrode 120. Wiring 170 among wirings 150 is connected to an end of transmission electrode 130 in direction X2. An end of transmission electrode 130 in direction X1 is opened. Terminal 175 is provided at an end of wiring 170 opposite to the end of wiring 170 connected to transmission electrode 130.

As shown in FIG. 2, transmission electrode 120A extends slenderly in direction X1, i.e., in direction X2. Wiring 160A is connected to an end of transmission electrode 120A in direction X1. An end of transmission electrode 120A in direction X2 is opened. Wiring 160A extends from an end of wiring 160A connected to transmission electrode 120A through a peripheral portion of substrate 100 which is located in direction X1. Terminal 165A is provided at a tip end of wiring 160A.

Transmission electrode 130A is spaced from transmission electrode 120A in direction Y2 by a predetermined interval. Transmission electrode 130A extends parallel to transmission electrode 120A. An end of transmission electrode 130A in direction X1 is opened. Wiring 170A is connected to an end of transmission electrode 130A in direction X2. Wiring 170A extends from the end of wiring 170A connected to transmission electrode 130A though a peripheral portion of substrate 100 which is located in direction X2. Terminal 175A is provided at a tip end of wiring 170A.

Transmission electrode 120B is spaced from transmission electrode 130A in direction Y2 by a predetermined interval. Transmission electrode 120B extends parallel to transmission electrode 130A. Wiring 160B is connected to an end of transmission electrode 120B in direction X1. An end of transmission electrode 120B in direction X2 is opened. Similarly to wiring 160A, wiring 160B extends from the end of wiring 160B connected to transmission electrode 120B through a peripheral portion of substrate 100 which is located in direction X1. Terminal 165B is provided at a tip end of wiring 160B.

Transmission electrode 130B is spaced from transmission electrode 120B in direction Y2 by a predetermined interval. Transmission electrode 130B extends parallel to transmission electrode 120B. An end of transmission electrode 130B in direction X1 is opened. An end of transmission electrode 130B in direction X2 is connected to wiring 170B. Wiring 170B extracts from the end of wiring 170B connected to transmission electrode 130B through a peripheral portion of substrate 100 which is located in direction X2. Terminal 175B is provided at a tip end of wiring 170B. Transmission electrodes 120 and transmission electrodes 130 are thus arranged alternately in direction Y2.

As mentioned above, transmission electrodes 110 are disposed such that transmission electrodes 120A, 130A, 120B, 130B, . . . are arranged in direction Y2 in this order on upper surface 100A of substrate 100.

FIG. 2 shows transmission electrodes 120A, 120B, 120C, 130A, and 130B among transmission electrodes 110. Each transmission electrode 110 shown in FIG. 2 in accordance with the embodiment includes rectangular portions 110P arranged in direction X2 (X1) at constant pitches in direction X2 (X1) and connected with one another. However, the shape of transmission electrodes 110 is not limited to it. For instance, each transmission electrode 110 may have a linear shape which does not include rectangular portion 110P, or may have a shape other than rectangular portion 110P. Transmission electrodes 110 have shapes substantially identical to each other when viewed from direction X1. In other words, transmission electrodes 110 preferably have shapes identical to each other such that any one transmission electrode among transmission electrodes 110 substantially completely overlaps another transmission electrode when the any one transmission electrode is translated. Each transmission electrode 110, for example, transmission electrode 120B is preferably symmetrical about straight line L1 that passes through center C0 of transmission electrode 120B in direction X1 (X2) and that is parallel to direction X1 (X2). In addition to this, transmission electrode 120B is preferably symmetrical about straight line L1 that passes through center C0 of transmission electrode 120B in direction Y1 (Y2) and that is perpendicular to direction Y1 (Y2).

Wirings 150 are preferably made of conductive metal, such as copper, but not limited to it. Wirings 150 may be made of the same material as transmission electrodes 110. Wirings 150 may be made of thin metal wirings made of conductive metal, such as copper or silver, and arranged along a mesh pattern. The thin metal wirings have line widths of several micrometers.

Receiving electrode 220 will be described below with reference to FIG. 3. As shown in FIG. 3, receiving electrodes 220 substantially have strip shapes linearly extending, similarly to transmission electrodes 110. Receiving electrodes 220 are parallel to one another, and substantially have strip shapes extending slenderly and linearly in direction Y1. Each receiving electrode 220 shown in FIG. 3 in accordance with the embodiment includes rectangular portions 220P that are arranged at constant pitches in direction Y2 (Y1) and connected with one another. However, the shape of receiving electrodes 220 is not limited to this. For instance, each receiving electrode 220 may have a linear shape which does not include rectangular portions 220P, or may have a shape other than rectangular portions 220P. Receiving electrodes 220 are arranged at predetermined pitches in direction X1 (X2). In accordance with the embodiment, the predetermined pitches are constant. Wirings 250 are connected to respective one ends of receiving electrodes 220 in direction Y2. Terminals 265 are provided at ends of wirings 250 opposite to the ends of wirings 250 connected to receiving electrodes 220. Wirings 250 are preferably made of conductive metal such, as copper, but not limited to this. Wirings 250 may be made of the same material as receiving electrodes 220. Receiving electrodes 220 and wirings 250 may be made of thin metal wirings that are made of conductive metal, such as copper or silver and that are arranged along a mesh pattern. The thin metal wirings have line widths of several micrometers.

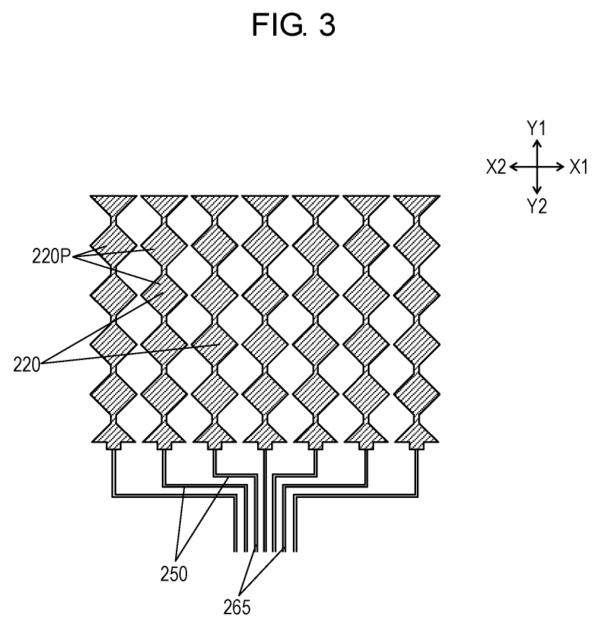

FIG. 4 is a block diagram of touch panel device 800 in accordance with the embodiment. Touch panel device 800 includes touch panel 500 and controller 700 connected to terminals 165 and 265 of touch panel 500. As shown in FIG. 1B, touch panel 500 including transmission electrodes 110 and receiving electrodes 220 is mounted to an electronic device such that touch panel 500 is attached to cover lens 600 and disposed in front of an indicator. While being mounted to the electronic device, touch panel 500 is connected to controller 700, as shown in FIG. 4. Each of receiving electrodes 220 receives electric field from respective one of transmission electrodes 110. A user performs an operation, such as touching a surface of cover lens 600 with a finger, while visually recognizing items displayed on the indicator. This operation changes the intensity of the electric fields received by receiving electrodes 220. In other words, capacitance to be obtained is changed. According to values of the capacitance, controller 700 calculates a position touched with the finger to operate functions of the electronic device.

An operation of touch panel 500 will be described below.

In touch panel 500, controller 700 drives two of transmission electrodes 110 adjacent to each other simultaneously as a pair. Thus, the two of transmission electrodes 110 adjacent to each other are driven and activated simultaneously.

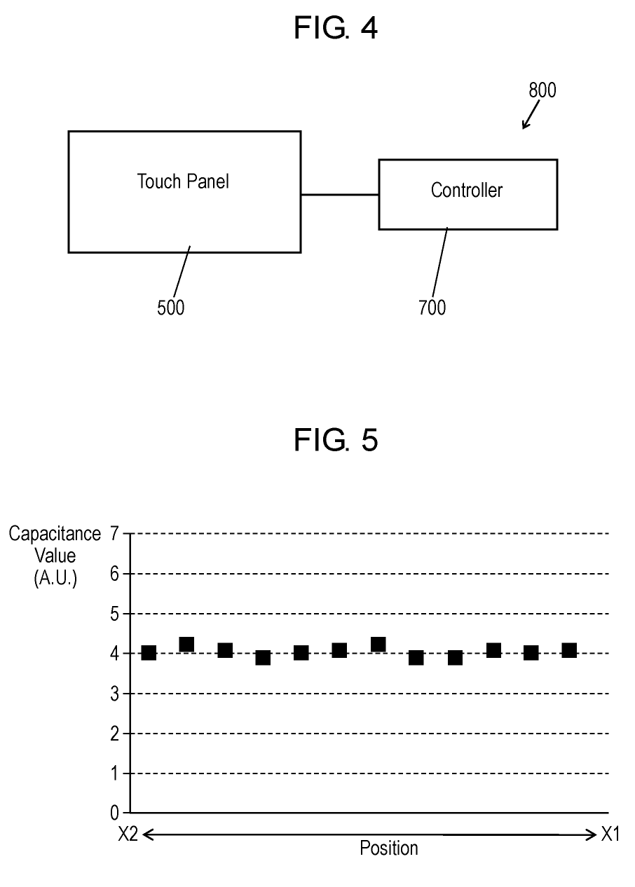

First, controller 700 operates transmission electrodes 120A and 130A simultaneously. In other words, upon having a predetermined potential, for example, input to terminal 165A shown in FIG. 2, controller 700 drives transmission electrode 120A through wiring 160A with particular signal 2A1. Upon having a predetermined potential, for example, input to terminal 175A simultaneously to terminal 165A, controller 700 drives transmission electrode 120B through wiring 170A with particular signal 3A1. Particular signals 2A1 and 3A1 input to transmission electrodes 120A and 120B are preferably identical to each other in voltage values, lengths and timings of driving time identical to each other. The following description will explain the case where transmission electrodes 110, which are used as a pair, are driven under this condition. While transmission electrodes 120A and 130A are driven and activated simultaneously as described above, receiving electrodes 220 receive electric fields from transmission electrodes 120A and 130A, thereby obtaining capacitance values corresponding to the intensity of the electric fields received in receiving electrodes 220. FIG. 5 shows the capacitance values to be obtained. In detail, FIG. 5 shows capacitance values obtained when the transmission electrodes adjacent to each other are activated simultaneously. In FIG. 5, a horizontal axis represents a position on the transmission electrodes in direction X1 (X2), and a vertical axis represents a capacitance value obtained at the position expressed in an arbitrary unit (A.U.). As shown in FIG. 5, the obtained capacitance value is substantially constant along direction X1, thus being uniform. Receiving electrodes 220 provided on substrate 200 have strip shapes extending slenderly in a direction perpendicular to transmission electrodes 110. Receiving electrodes 220 are spaced from transmission electrodes 110 at constant intervals.

When transmission electrodes 120A and 130A are activated simultaneously as a pair with signals 2A1 and 3A1 identical to each other, respectively, electric fields generated by transmission electrodes 120A and 130A which are driven act on receiving electrodes 220, thereby providing the capacitance values shown in FIG. 5. At this moment, the intensity of the electric field at an open end of transmission electrode 120A in direction X2 decreases due to an influence of a voltage drop caused by the resistance of transmission electrode 120A. The intensity of the electric field at an open end of transmission electrode 130A in direction X1 decreases due to an influence of voltage a drop caused by the resistance of transmission electrode 130A. In other words, at the ends of transmission electrodes 120A and 130A in direction X1, a strong electric field from transmission electrode 120A and a weak electric field from transmission electrode 130A act on receiving electrodes 220 simultaneously. On the other hand, at the ends of transmission electrodes 120A and 130A in direction X2, a weak electric field from transmission electrode 120A and a strong electric field from transmission electrode 130A act on receiving electrodes 220 simultaneously. Since transmission electrodes 110 have the same shapes, driving states of transmission electrode 120A and transmission electrode 130A which are opposite to each other in direction X1 (X2) are identical or substantially identical to each other. Thus, an identical or substantially identical electric field acts on receiving electrodes 220 both at the ends of transmission electrodes 120A and 130A in direction X1 and at the ends of transmission electrodes 120A and 130A in direction X2. Accordingly, the intensity of the electric field received in receiving electrodes 220 has identical or substantially identical magnitude both at the ends of transmission electrodes 120A and 130A in direction X1 and at the ends of transmission electrodes 120A and 130A in direction X2. Therefore, capacitance values to be obtained have identical or substantially identical magnitude, thereby providing identical or substantially identical capacitance values, i.e., constant and uniform capacitance values along direction X1 (X2).

Subsequently, controller 700 switches the two of transmission electrodes 110 as a pair shown in FIG. 2 from a pair of transmission electrodes 120A and 130A to a pair of transmission electrodes 130A and 120B. Then, controller 700 drives and activates transmission electrodes 130A and 120B simultaneously with signals 3A2 and 2B1 identical to each other, respectively. Particular signal 3A2 input to transmission electrode 130A is identical to particular signal 3A1 mentioned above. Controller 700 applies, e.g. a predetermined potential to terminal 175A. Thus, controller 700 drives transmission electrode 130A through wiring 170A with particular signal 3A2. Simultaneously to this, controller 700 applies, e.g. a predetermined potential to terminal 165B. Thus, controller 700 drives transmission electrode 120B through wiring 160B with particular signal 2B1. Particular signals 2B1 and 3A2 input to transmission electrodes 120B and 130A are identical to each other in voltage values, lengths and timings of driving time. Even in this case, capacitance values to be obtained are the same as the capacitance values shown in FIG. 5, i.e., the capacitance values obtained when above-mentioned transmission electrodes 120A and 130A are activated simultaneously. In other words, uniform and constant capacitance values with identical magnitude are obtained along direction X1 (X2).

Also in a combination of transmission electrodes 130A and 120B, transmission electrodes 130A and 120B are driven to generate electric fields. The electric fields act on receiving electrode 220, so that the above-mentioned capacitance values are obtained. For instance, at ends of transmission electrodes 130A and 120B in direction X2, a strong electric field from transmission electrode 130A and a weak electric field from transmission electrode 120B act on receiving electrodes 220 simultaneously. At ends of transmission electrodes 130A and 120B in direction X1, a weak electric field from transmission electrode 130A and a strong electric field from transmission electrode 120B act on receiving electrodes 220 simultaneously. As mentioned above, since transmission electrodes 110 have the same shape, driving states of transmission electrode 130A and transmission electrode 120B, which are opposite to each other in direction X1 (X2), are identical or substantially identical to each other. Thus, an identical electric field acts on receiving electrodes 220 both at the ends of transmission electrodes 130A and 120B in direction X1 and at the ends of transmission electrodes 130A and 120B in direction X2. Therefore, capacitance values to be obtained have identical magnitude both at the ends of transmission electrodes 130A and 120B in direction X1 and at the ends of transmission electrodes 130A and 120B in direction X2, thereby providing identical capacitance values, i.e., constant and uniform capacitance values along direction X1 (X2).

After that, similarly, controller 700 switches the two of transmission electrodes 110 as a pair from a pair of transmission electrodes 120B and 130A to a pair of transmission electrodes 120B and 130B. Then, controller 700 drives and activates transmission electrodes 120B and 130B simultaneously with the same signals 2B2 and 3B1, respectively. Particular signal 2B2 input to transmission electrode 120B is the same as particular signal 2B1 mentioned above. Transmission electrode 120B is driven through terminal 165B and wiring 160B. Transmission electrode 130B is driven through terminal 175B and wiring 170B. Note that, particular signals 2B2 and 3B1 input to transmission electrodes 120B and 130B are identical to each other in drive voltage values, lengths and timings of driving time.

After that, similarly, controller 700 switches the two of transmission electrode 110 as a pair shown in FIG. 2 from a pair of transmission electrodes 120B and 130B to a pair of transmission electrodes 120C and 130B. Then, controller 700 drives and activates transmission electrodes 120C and 130B simultaneously with the same signals 2B2 and 3B1, respectively. Particular signal 3B2 input to transmission electrode 130B is identical to particular signal 3B1 mentioned above. Transmission electrode 120C is driven through terminal 165C and wiring 160C. Transmission electrode 130B is driven through terminal 175B and wiring 170B. Note that, particular signals 2C1 and 3B2 input to transmission electrodes 120C and 130B are the same signals in drive voltage values, lengths and timings of driving time.

Subsequently, controller 700 further changes the two of transmission electrodes 110 as a pair in direction Y2 one by one, and simultaneously drives and activates the two of transmission electrodes 110 adjacent to each other in direction Y1 (Y2) as the pair simultaneously. As a result, in any pair, uniform and constant capacitance values with identical magnitude are obtained along direction X1 (X2).

When detection area 500A of touch panel 500 is touched or approached by an object, such as a finger, the capacitance value changes locally at a position on touch panel 500 touched or approached by the object. By detecting the local change of the capacitance value, controller 700 detects the position on touch panel 500 touched or approached by the object.

In a touch panel of a capacitive type, accurate detection is required for touch operation. In the touch panel disclosed in PTL 1, only respective one ends of all of transmission electrodes formed on a lower substrate are connected to wirings while respective another ends thereof are opened. Further, all of the transmission electrodes are disposed such that their open ends are directed to the same side. When respective one of the transmission electrodes is driven through each of the wirings, intensity of electric field from the respective one of the transmission electrodes is weakened due to an influence of voltage drop as it approaches its open end. For this reason, electric field intensity of the receiving electrodes that is received at positions corresponding to the another ends of the transmission electrodes is reduced, as compared with electric field intensity of the receiving electrodes that is received at positions corresponding to the one ends of the transmission electrodes. In other words, capacitance values obtained at the positions corresponding to the other ends of the transmission electrodes are different from capacitance values obtained at the positions corresponding to the one ends of the transmission electrodes.

In a touch panel of a capacitive type, accurate detection is required for touch operation. As mentioned above, in the touch panel disclosed in PTL 1, if the capacitance values to be obtained are difference, detection accuracy at touch operation may be adversely affected.

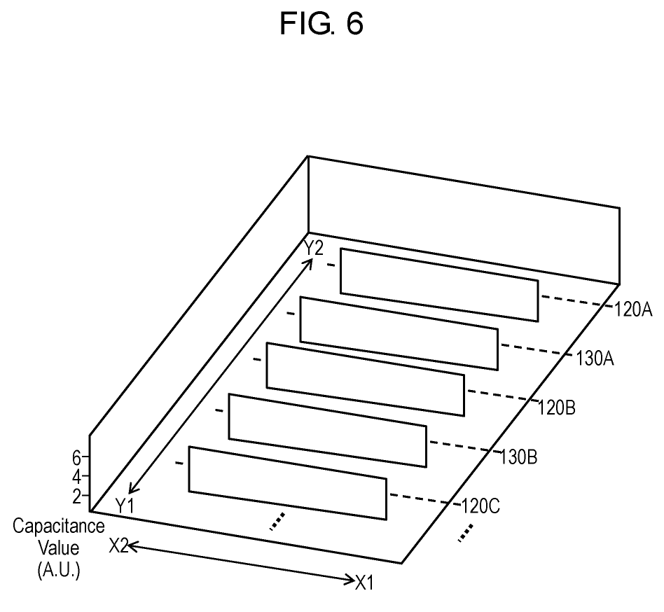

In touch panel 500 in accordance with of the embodiment, two of transmission electrodes 110 adjacent to each other in direction Y1 (Y2) constitute each of plural pairs. Controller 700 drives the two of transmission electrodes 110, constituting each of the plural pairs, simultaneously. Controller 700 drives and activates the plural pairs in sequence one by one. Note that, controller 700 switches transmission electrodes 110 as a pair in sequence from two of transmission electrodes 110 located at an end in direction Y1 to two of transmission electrodes 110 located at an end in direction Y2. FIG. 6 schematically shows capacitance values obtained when the plural pairs are operated one by one. FIG. 6 shows capacitance values obtained when transmission electrodes adjacent to each other are activated simultaneously. In FIG. 6, the X-axis represents a position of the transmission electrodes adjacent to each other in direction X1 (X2), and the Y-axis represents a position of the transmission electrodes adjacent to each other in direction Y1 (Y2). The Z-axis represents the obtained capacitance values in an arbitrary unit (A.U.). In other words, in FIG. 6, transmission electrodes 110 are arranged in an X-Y plane including the X-axis and the Y-axis, and the obtained capacitance values are shown.

As shown in FIG. 6, in touch panel 500, when the plural pairs of transmission electrodes 110 each constituted by two of transmission electrodes 110 adjacent to each other are activated simultaneously and respective one of the plural pairs to be activated is shifted sequentially in direction Y2, the obtained capacitance values are substantially the same in any direction, i.e., any of direction X1 (X2) and direction Y1 (Y2). Thus, controller 700 preferably detects the touch operation of touch panel 500. Further, correction processing at the time of the detection can also be reduced.

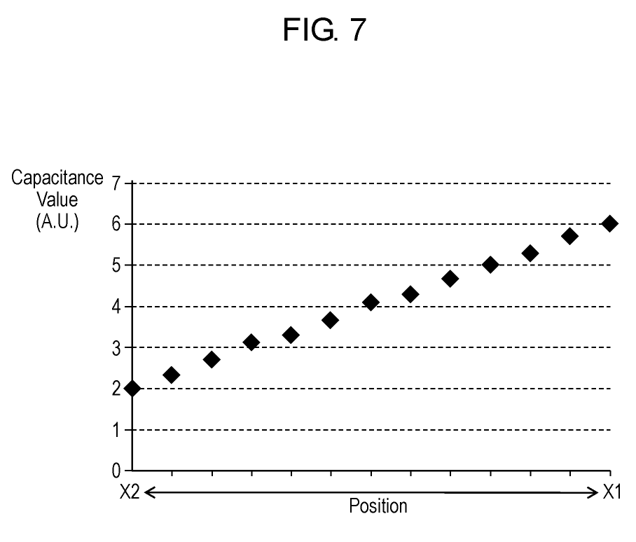

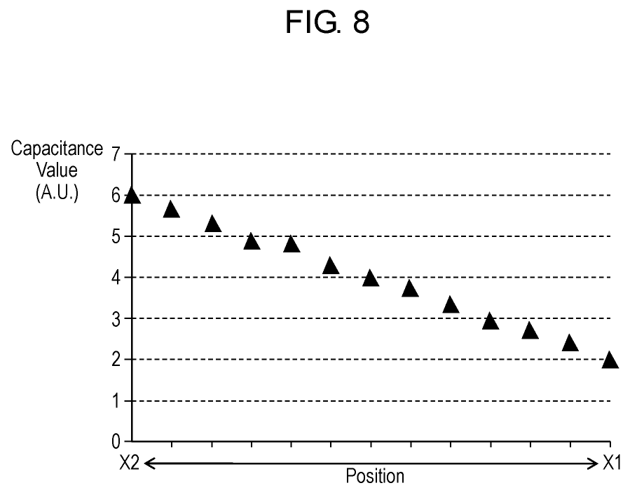

Next, an operation of a comparative example will be described. In the comparative example, transmission electrodes 110 of touch panel 500 are driven and activated one by one sequentially. FIG. 7 shows capacitance values in direction X1 (X2) of transmission electrodes 120 obtained when transmission electrodes 120 are activated one by one in touch panel 500. FIG. 8 shows capacitance values obtained when transmission electrodes 130 are activated one by one in touch panel 500. In FIGS. 7 and 8, the horizontal axis represents a position in direction X1 (X2) of transmission electrodes 120 or 130 in direction X1 (X2), and the vertical axis represents a capacitance value in an arbitrary unit (A.U.) at the position.

First, only transmission electrode 120A is driven and activated. In this case, receiving electrodes 220 receive an electric field from transmission electrode 120A, and obtains a capacitance value according to intensity of the electric field received in receiving electrodes 220. The obtained capacitance value is shown in FIG. 7. As shown in FIG. 7, a larger capacitance value is obtained at an end of transmission electrode 120A in direction X1, and a smaller capacitance value is obtained at the end of transmission electrode 120A in direction X2 than the center of transmission electrode 120A in direction X1 (X2). The obtained capacitance value gradually decreases from the end of transmission electrode 120A in direction X1 to the end of transmission electrode 120A in direction X2. This is because a voltage drop is increased as approaching the end of transmission electrode 120A in direction X2 being an open end, and intensity of the electric field generated at the end of transmission electrode 120A in direction X2 is decreased as compared with intensity of the electric field generated at the end of transmission electrode 120A in direction X1 which is connected to wiring 160A. Since transmission electrodes 110 other than transmission electrode 120A are not driven and activated, only an electric field from transmission electrode 120A acts on receiving electrodes 220. Therefore, intensity of the electric field received in receiving electrodes 220 decreases from the end of transmission electrode 120A in direction X1 to the end of transmission electrode 120A in direction X2, so that the obtained capacitance value is decreased from the end of transmission electrode 120A in direction X1 to the end of transmission electrode 120A in direction X2. Note that, a difference between the capacitance values obtained along direction X1 (X2) will be increased due to an influence of the voltage drop if the length of transmission electrode 110 increases according to, e.g. enlargement of the size of the touch panel.

Next, only transmission electrode 130A is driven and activated. In this case, as shown in FIG. 8, a smaller capacitance value is obtained at an end of transmission electrode 130A in direction X1, and a larger capacitance value is obtained at an end of transmission electrode 130A in direction X2 than the center of transmission electrode 130A in direction X1 (X2). The obtained capacitance value gradually increases from the end of transmission electrode 130A in direction X1 to the end of transmission electrode 130A in direction X2. This is because a voltage drop is increased as approaching the end of transmission electrode 130A in direction X1 which is an open end. Intensity of the electric field generated at the end of transmission electrode 130A in direction X1 is decreased as compared with intensity of the electric field generated at the end of transmission electrode 130A in direction X2 which is connected to wiring 170A. Since transmission electrodes 110 other than transmission electrode 130A are not driven and activated, only an electric field from transmission electrode 130A acts on receiving electrodes 220. Therefore, intensity of the electric field received in receiving electrodes 220 increases from the end of transmission electrode 130A in direction X1 to the end of transmission electrode 130A in direction X2, so that the obtained capacitance value is increased from the end of transmission electrode 130A in direction X1 to the end of transmission electrode 130A in direction X2. Note that, a difference between the capacitance values along direction X1 (X2) increases as the length of transmission electrode 110 increases according to, e.g. enlargement the size of the touch panel. Note that, since transmission electrodes 110 have the same shape and the same driving state, the small capacitance value at the open end of transmission electrode 120A which is obtained when only transmission electrode 120A is activated is substantially the same as the small capacitance value at the open end of transmission electrode 130A which is obtained when only transmission electrode 130A is activated. The large capacitance value at the end of transmission electrode 120A in direction X1 connected to one of wirings 150 is obtained when only transmission electrode 120A is activated. This large capacitance value is substantially the same as the large capacitance value at the end of transmission electrode 130A in direction X2 connected to one of wirings 150, which is obtained when only transmission electrode 130A is activated.

Subsequently, only transmission electrode 120B is driven and activated. In this case, an obtained capacitance value is identical to the capacitance value obtained when only transmission electrode 120A is driven and activated. In other words, due to the above-mentioned voltage drop, a larger capacitance value is obtained at an end of transmission electrode 120B in direction X1 while a smaller capacitance value is obtained at the end of transmission electrode 120B in direction X2 than the center in direction X1 (X2) of transmission electrode 120B. The capacitance value is decreased gradually from the end of transmission electrode 120B in direction X1 to the end of transmission electrode 120B in direction X2. The capacitance value obtained when only transmission electrode 120B is driven and activated is thus identical to the capacitance value obtained when only transmission electrode 120A is driven and activated. Besides, due to the above-mentioned voltage drop, the capacitance value obtained when only transmission electrode 130B is driven and activated is identical to the capacitance value obtained when only transmission electrode 130A is driven and activated.

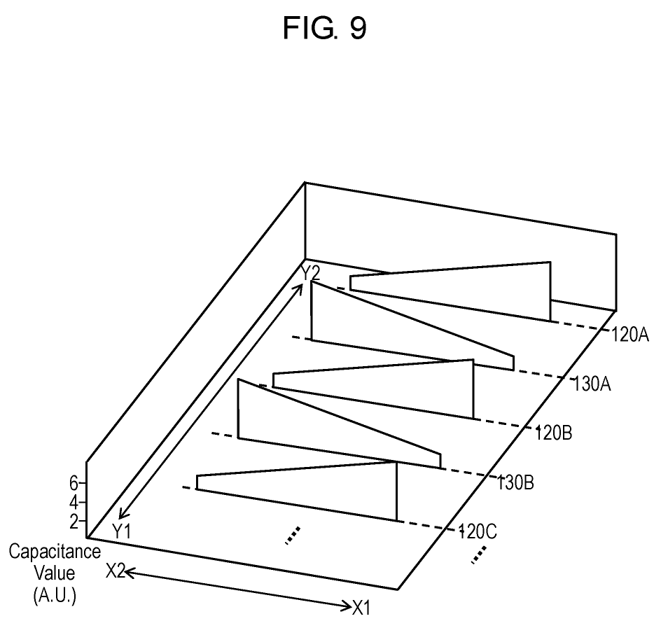

FIG. 9 schematically shows capacitance values obtained when transmission electrodes 110 are driven and activated one by one from an end of transmission electrodes 110 in direction Y1 to an end of transmission electrodes 110 in direction Y2, as mentioned above. In FIG. 9, the X-axis represents a position on transmission electrodes 110 in direction X1 (X2), the Y-axis represents a position on transmission electrodes 110 in direction Y1 (Y2), and the Z-axis represents a capacitance value. In other words, FIG. 9 shows capacitance values obtained when transmission electrodes 110 are arranged in an X-Y plane including the X-axis and the Y-axis.

As shown in FIG. 9, when transmission electrodes 110 are driven and activated one by one sequentially, the obtained capacitance values are inclined such that the capacitance value at the end of transmission electrodes 110 in direction X1 is larger than that at the end of transmission electrodes 110 in direction X2, and inclined such that the capacitance value at the end of transmission electrodes 110 from in direction X1 is smaller than that at the end of transmission electrodes 110 in direction X2. These inclinations are alternately repeated. In other words, the obtained capacitance values are inclined along direction X1 (X2) of transmission electrodes 110, and the inclinations have opposite directions to each other in direction Y1 (Y2) of transmission electrodes 110. In this case, a detection accuracy is hardly achieved in touch operation.

As mentioned above, in touch panel 500 in accordance with the embodiment, transmission electrodes 120 and 130 are alternately arranged in direction Y1 (Y2). Each of plural pairs of transmission electrodes is constituted by corresponding two of transmission electrodes 120 and 130 which are adjacent to each other. The corresponding two transmission electrodes constituting respective one pair are driven and activated simultaneously. This operation provides capacitance values uniform and constant in direction X1 (X2) and direction Y1 (Y2) of transmission electrodes 120 and 130, hence allowing the touch operation to be detected accurately. Further, this operation reduces eliminates processing at detection. Transmission electrodes 120A, 120B, . . . are connected to wirings 160A, 160B, . . . disposed on only a side of transmission electrodes 120 in direction X1, respectively. Transmission electrodes 130A, 130B, . . . are connected to wirings 170A, 170B, . . . disposed on only a side of transmission electrodes 130 in direction X2, respectively. In other words, wirings 150 are connected to ends of transmission electrodes 110 only on one side, thereby narrowing peripheral portion 500B (see FIG. 1B) of detection area 500A in which transmission electrodes 110 are arranged. Therefore, a narrow-frame configuration is also be achieved.

In the above description, two of transmission electrodes 110 adjacent to each other in direction Y1 (Y2) among transmission electrodes 110 are employed as a pair to be activated simultaneously. The number of transmission electrodes 110 employed as a pair, however, is not limited to two. For instance, in the configuration shown in FIG. 2, four of transmission electrodes 110 adjacent to one another in direction Y1 (Y2) may be activated simultaneously. For instance, controller 700 drives and operates transmission electrodes 120A, 120B, 130A, and 130B shown in FIG. 2 simultaneously with the same signals, and capacitance values between the above-mentioned transmission electrodes and receiving electrodes 220 are obtained. The capacitance values are uniform and constant in direction X1 (X2). After that, transmission electrode 120A located most outside in direction Y1 is removed, and transmission electrode 120C which is located most outside in direction Y2 and adjacent to transmission electrode 130B is added. Four transmission electrodes 120B, 120C, 130A, and 130B adjacent to one another are driven and activated simultaneously, and capacitance values between receiving electrodes 220 and each of the four transmission electrodes are obtained. The obtained capacitance values are uniform and the same as the capacitance values obtained when transmission electrodes 120A, 120B, 130A, and 130B are activated. Note that, in the configuration of activating four of transmission electrodes 110 simultaneously, transmission electrodes 120B, 130A, and 130B may be arranged in this order in direction Y2 from transmission electrode 120A. In other words, two transmission electrodes 120 and transmission electrodes 130 having the same number of transmission electrodes 120 may be arranged repetitively in direction Y1 (Y2).

As described above, transmission electrodes 110 include transmission electrodes 120A and 130A that are adjacent to each other in direction Y1 (Y2). Wirings 150 include wiring 160A connected to transmission electrode 120A, and wiring 170A connected to transmission electrode 130A. Transmission electrode 120A has one end connected to wiring 160A, and another end which is an open end. Transmission electrode 120A extends slenderly from the one end to the another end in direction X2. Transmission electrode 130A has one end connected to which 170A, and another end which is an open end. Transmission electrode 130A extends slenderly from the one end to the another end in direction X1 opposite to direction X2. Transmission electrode 120A and transmission electrode 130A are driven simultaneously with signal 2A1 and signal 3A1 input through wiring 160A and wiring 170A, respectively.

Transmission electrode 120A and transmission electrode 130A are made of materials identical to each other and have shapes substantially identical to each other. Transmission electrode 120A and the transmission electrode 130A may have shapes substantially identical to each other such that one of the two transmission electrodes, mentioned above, completely overlaps the other of the two transmission electrodes when the one of the two transmission electrodes is translated.

Transmission electrodes 110 may have shapes identical to each other, and may be made of materials identical to each other.

Transmission electrodes 110 may have shapes substantially identical to each other such that one of transmission electrodes 110 completely overlaps the other of transmission electrodes 110 when the one of transmission electrodes 110 is translated.

Signal 2A1 may be identical to signal 3A1.

Touch panel 500 further includes one or more receiving electrodes 220 facing transmission electrodes 110 in direction Z1 crossing direction Y1 (Y2) and direction X1 (X2) such that one or more receiving electrodes 220 are spaced from transmission electrodes 110.

One or more receiving electrodes 220 are arranged in direction X1 (X2), and substantially have strip shapes extending slenderly in direction Y1 (Y2).

Touch panel device 800 includes touch panel 500 and controller 700 that supplies signal 2A1 and signal 3A1 to touch panel 500.

Transmission electrodes 120 and transmission electrodes 130 are arranged in direction Y1 (Y2). Each of wirings 160 is connected to respective one of transmission electrodes 120. Each of wirings 170 is connected to respective one of transmission electrodes 130. Each of transmission electrodes 120 has one end connected to a wiring, and another end which is an open end. Each of transmission electrodes 120 substantially has a strip shape extending slenderly from the one end thereof to the another end thereof in direction X2 crossing direction Y1 (Y2). Each of transmission electrodes 130 has one end connected to a wiring, and has another end which is an open end. Each of transmission electrodes 130 substantially has a strip shape extending slenderly from the one end thereof to the another end thereof in direction X1 opposite to direction X2. Transmission electrode 120A among transmission electrodes 120 is adjacent to transmission electrode 130A among transmission electrodes 130 in direction Y1 (Y2). Transmission electrode 120A has one end connected to wiring 160A among wirings 160, and has another end which is an open end. Transmission electrode 120A extends slenderly from the one end thereof to the another end thereof in direction X2. Transmission electrode 130A has one end connected to wiring 170A among wirings 170, and another end which is an open ends. Transmission electrode 130A extends slenderly from the one end thereof to the another end thereof in direction X1. Transmission electrode 120A and transmission electrode 130A are driven simultaneously with signal 2A1 and signal 3A1 input through wiring 160A and wiring 170A, respectively.

Transmission electrodes 120 and transmission electrodes 130 are made of materials identical to each other, and may have shapes substantially identical to each other.

Transmission electrodes 120 and transmission electrodes 130 may have shapes identical to each other such that one of transmission electrodes 120 completely overlaps one of transmission electrodes 130 when the one of transmission electrodes 120 is translated.

Signal 2A1 may be identical to signal 3A1.

Transmission electrodes 120 and transmission electrodes 130 may be arranged alternately in direction Y1 (Y2).

Any transmission electrode 120A (120B, . . . ) among the transmission electrodes 120 is adjacent to particular transmission electrode 130A (130B, . . . ) among transmission electrodes 130 in direction Y1 (Y2). The any transmission electrode 120A (120B, . . . ) has one end connected to particular wiring 160A (160B, . . . ) among wirings 160, and has another end which is an open end. The any transmission electrode 120A (120B, . . . ) extends slenderly from the one end thereof to the another end thereof in direction X2 (X1). The particular transmission electrode 130A (130B, . . . ) has one end connected to particular wiring 170A (170B, . . . ) among wirings 170, and has another end which is an open end. The particular transmission electrode 130A (130B, . . . ) extends slenderly from the one end thereof to the another end thereof in direction X1 (X2). The any transmission electrode 120A (120B, . . . ) and the particular transmission electrode 130A (130B, . . . ) are driven simultaneously with signal 2A1 (2B1, . . . ) and particular signal 3B1 (3B2, . . . ) input through particular wiring 160A (160B, . . . ) and particular wiring 170A (170B, . . . ), respectively.

Particular signal 2A1 (2B1, . . . ) may be identical to particular signal 3B1 (3B2, . . . ).

Transmission electrodes 120 and transmission electrodes 130 may have shapes substantially identical to each other, and may be made of materials identical to each other,

Transmission electrodes 120 and transmission electrodes 130 may have shapes identical to each other such that one of transmission electrodes 120 completely overlaps one of transmission electrodes 130 when the one of transmission electrodes 120 is translated.

Touch panel 500 includes transmission electrodes 120 and one or more receiving electrodes 220 facing transmission electrodes 130 in direction Z1 crossing direction Y1 (Y2) and direction X1 (X2) such that the one or more receiving electrodes 220 are spaced from transmission electrodes 130.

One or more receiving electrodes 220 are arranged in direction X1 (X2), and may substantially have a strip shape extending slenderly in direction Y1 (Y2).

One or more receiving electrodes 220 may be plural receiving electrodes 220.

Controller 700 may further supply particular signal 3A2 (3B1, . . . ) to touch panel 500 in addition to signal 3A1, signal 3A1, and particular signal 2B1 (2B2, . . . ).

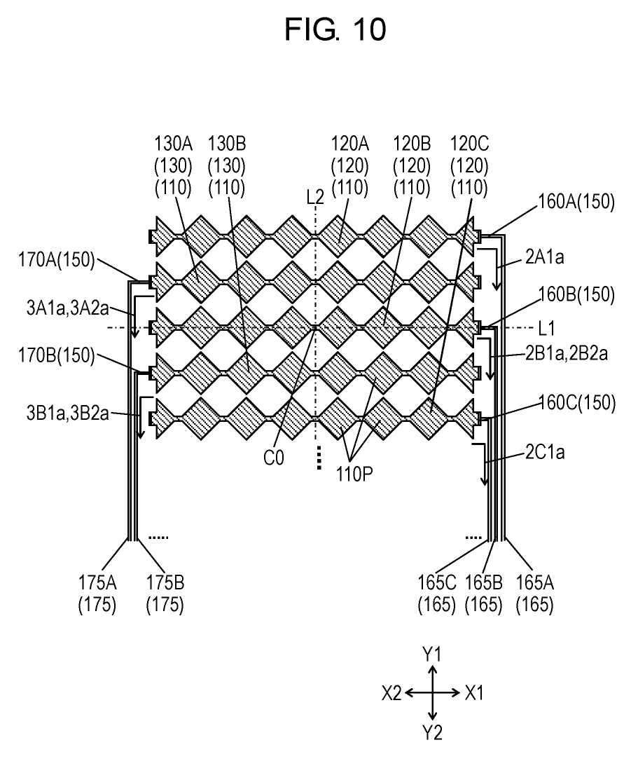

In the above-mentioned operation of touch panel device 800, a signal is input to transmission electrodes 110 (120, 130) of touch panel 500 to drive transmission electrodes 110, and touch panel device 500 detects whether touch panel 500 is touched or approached by an object, based on the signal output from receiving electrodes 220. As another operation, a signal is input to receiving electrodes 220 of touch panel 500 to drive receiving electrodes 220, and touch panel 500 detects whether touch panel 500 is touched approached by the object, based on the signal output from transmission electrode 110 (120, 130). FIG. 10 is a plan view of touch panel 500 for illustrating the above-mentioned operation. In FIG. 10, components identical to those of touch panel 500 shown in FIGS. 1A to 7 are denoted by the same reference numerals. In the operation shown in FIG. 10, transmission electrodes 120 (120A, 120B, . . . ) and 130 (130A, 130B, . . . ) function as a lateral electrodes that outputs signals. Receiving electrodes 220 function as longitudinal electrodes that receive the signals to drive receiving electrodes 220. This operation will be detailed below.

The operation shown in FIG. 10 will be detailed below. First, controller 700 inputs signals to longitudinal electrodes (receiving electrodes) 220 to drive the electrodes. Controller 700 detects signals 2A1a and 3A1a obtained simultaneously from lateral electrodes (transmission electrodes) 120A and 130A through wirings 160A and 170A, respectively. Controller 700 obtains an electrostatic capacitance value based on signal 2A1a and 3A1a. In accordance with the embodiment, controller 700 combines and adds signal 2A1a and signal 3A1a together to obtain the capacitance value. For one signal input to longitudinal electrodes (receiving electrodes) 220, signals 2A1a and 3A1a are thus detected. Signals 2A1a and 3A1a are obtained from lateral electrodes (transmission electrodes) 120A and 130A, simultaneously. Under this condition, the electric field generated by the drove longitudinal electrodes (receiving electrodes) 220 acts on lateral electrodes (transmission electrode) 120A and 130A. Signals 2A1a and 3A1a obtained in lateral electrodes (transmission electrodes) 120A and 130A are combined and added together to obtain the capacitance value, which is uniform and constant along direction X1 (X2) as shown in FIG. 5.

Subsequently, controller 700 switches two of lateral electrodes (transmission electrodes) 110 as a pair shown in FIG. 2 from a pair of lateral electrodes (transmission electrodes) 120A and 130A to a pair of lateral electrodes (transmission electrodes) 130A and 120B. Controller 700 inputs signals to longitudinal electrodes (receiving electrodes) 220 to drive longitudinal electrodes 220, and detects signals 3A2a and 2B1a that are obtained simultaneously from lateral electrodes (transmission electrode) 130A and 120B through wirings 170A and 160B. Controller 700 obtains a capacitance value based on signal 3A2a and 2B1a. Similarly to above, controller 700 combines and adds signals 3A2a and 2B1a together to obtain a capacitance value, which is the same as the capacitance value shown in FIG. 5. In other words, a uniform and constant capacitance value with the same magnitude is obtained along direction X1 (X2).

After that, controller 700 switches two of lateral electrodes (transmission electrodes) 110 as a pair from a pair of lateral electrodes (transmission electrodes) 120B and 130A to a pair of lateral electrodes (transmission electrodes) 120B and 130B, similarly to the above-mentioned operation. Controller 700 drives longitudinal electrodes (receiving electrodes) 220 and detects signals 2B2a and 3B1a that are obtained simultaneously from lateral electrodes (transmission electrodes) 120B and 130B through wirings 160B and 170B. Controller 700 combines adds signal 2B2a and 3B1a to obtain a capacitance value.

After that, controller 700 switches two of lateral electrodes (transmission electrodes) 110 as a pair shown in FIG. 2 from a pair of lateral electrodes (transmission electrodes) 120B and 130B to a pair of lateral electrodes (transmission electrodes) 120C and 130B, similarly to the above operation. Controller 700 drives longitudinal electrodes (receiving electrodes) 220 and detects signals 2C1a and 3B2a that are obtained simultaneously from lateral electrodes (transmission electrodes) 120C and 130B through wirings 160C and 170B. Controller 700 combines signal 2C1a and 3B2a to obtain a capacitance value.

Subsequently, controller 700 further shifts transmission electrodes 110 in direction Y2 one by one to employ two of transmission electrodes 110 adjacent to each other in direction Y1 (Y2) as a pair. Controller 700 drives longitudinal electrodes (receiving electrodes) 220 and detects signals obtained simultaneously from these lateral electrodes (transmission electrodes) 110 through wirings 150. Controller 700 combines and adds the signals together to obtain a capacitance value. As a result, in any pair, a uniform and constant capacitance value with the same magnitude is obtained along direction X1 (X2).

When detection area 500A of touch panel 500 is touched or approached by an object, such as a finger, a capacitance value changes locally at a position on detection area 500A which is touched approached by the object. By detecting a change in capacitance the value based on the signals obtained as mentioned above, controller 700 detects the position on touch panel 500 touched or approached by the object.

In the embodiment, terms, such as “upper surface,” “above,” “lateral,” and “longitudinal” indicating directions merely indicate relative directions determined only by relative positional relationship among components, such as a substrate and electrodes, of the touch panel, and do not indicate absolute directions, such as a vertical direction.

### INDUSTRIAL APPLICABILITY

A touch panel in accordance with the present invention is excellent in detection accuracy, and useful as a touch panel is for various electronic devices.

### REFERENCE MARKS IN THE DRAWINGS

100 substrate
110 transmission electrode, lateral electrode
120, 120A, 120B, 120C transmission electrode (first transmission electrode, first lateral electrode)
130, 130A, 130B transmission electrode, lateral electrode (second transmission electrode, second lateral electrode)
150, 250 wiring
160, 160A, 160B wiring (first wiring)
170, 170A, 170B wiring (second wiring)
165, 165A, 165B terminal
175, 175A, 175B terminal
200 substrate
220 receiving electrode, longitudinal electrode
265 terminal
300, 310 adhesive layer
500 touch panel
600 cover lens
700 controller
X1 direction (second direction)
Y1 direction (first direction)

1. A touch panel comprising:
a plurality of transmission electrodes arranged in a first direction, the plurality of transmission electrodes having strip shapes slenderly extending in a second direction crossing the first direction; and
a plurality of wirings each connected to respective one of the plurality of transmission electrodes,
wherein the plurality of transmission electrodes include a first transmission electrode and a second transmission electrode adjacent to each other in the first direction,
wherein the plurality of wirings include a first wiring connected to the first transmission electrode, and a second wiring connected to the second transmission electrode,
wherein the first transmission electrode has one end and another end to extend slenderly from the one end thereof to the another end thereof in the second direction, the one end of the first transmission electrode being connected to the first wiring, and the another end of the first transmission electrode being an open end,
wherein the second transmission electrode has one end and another end to extend slenderly from the one end thereof to the another end thereof in a direction opposite to the second direction, the one end of the second transmission electrode being connected to the second wiring, the another end of the second transmission electrode being an open end, and
wherein the first transmission electrode and the second transmission electrode are driven simultaneously by a first signal and a second signal that are input through the first wiring and the second wiring, respectively.

2. The touch panel of claim 1, wherein the first transmission electrode and the second transmission electrode have shapes substantially identical to each other, and are made of materials identical to each other.

3. The touch panel of claim 1, wherein the first signal is identical to the second signal.

4. The touch panel of claim 1, further comprising one or more receiving electrodes facing the plurality of transmission electrodes in a third direction crossing the first direction and the second direction such that the one or more receiving electrodes facing the plurality of transmission electrodes are spaced from the plurality of transmission electrodes.

5. The touch panel of claim 4, wherein the one or more receiving electrodes are arranged in the second direction, and substantially have strip shapes extending slenderly in the first direction.

6. A touch panel device comprising:
the touch panel of claim 1; and
a controller that supplies the first signal and the second signal to the touch panel.

7. A touch panel comprising:
a plurality of first transmission electrodes and a plurality of second transmission electrodes arranged in a first direction;
a plurality of first wirings each connected to respective one of the plurality of first transmission electrodes; and
a plurality of second wirings each connected to respective one of the plurality of second transmission electrodes,
wherein each of the plurality of first transmission electrodes has one end and another end to substantially have a strip shape extending slenderly from the one end thereof to the another end thereof in a second direction crossing the first direction, the one end of the each of the plurality of first transmission electrodes being connected to respective one of the plurality of first wirings, the another end of the each of the plurality of first transmission electrodes being an open end,
wherein each of the plurality of second transmission electrodes has one end and another end to substantially have a strip shape extending slenderly from the one end thereof to the another end thereof in a direction opposite to the second direction, the one end of the each of the plurality of second transmission electrodes being connected to respective one of the plurality of second wirings, the another end of the each of the plurality of second transmission electrodes being an open end, and
wherein a first transmission electrode among the plurality of first transmission electrodes is adjacent to a second transmission electrode among the plurality of second transmission electrodes in the first direction,
wherein the first transmission electrode has one end and another end to extend slenderly from the one end thereof to the another end thereof in the second direction, the one end of the first transmission electrode being connected to a first wiring among the plurality of first wirings, the another end of the first transmission electrode being an open end,
wherein the second transmission electrode has one end and another end to extend slenderly from the one end thereof to the another end thereof in the direction opposite to the second direction, the one end of the second transmission electrode being connected to a second wiring among the plurality of second wirings, the another end of the second transmission electrode being an open end, and
wherein the first transmission electrode and the second transmission electrode are driven simultaneously by a first signal and a second signal that are input through the first wiring and the second wiring, respectively.

8. The touch panel of claim 7, wherein the plurality of first transmission electrodes and the plurality of second transmission electrodes have shapes substantially identical to each other, and are made of materials identical to each other.

9. The touch panel of claim 7, wherein the first signal is identical to the second signal.

10. The touch panel of claim 7, wherein the plurality of first transmission electrodes and the plurality of second transmission electrodes are arranged alternately in the first direction.

11. The touch panel of claim 10,
wherein any first transmission electrode among the plurality of first transmission electrodes is adjacent to a particular second transmission electrode among the plurality of second transmission electrodes in the first direction,
wherein the any first transmission electrode has one end and another end to extend slenderly from the one end thereof to the another end thereof in the second direction, the one end of the any first transmission electrode being connected to a particular first wiring among the plurality of first wirings, the another end of the any first transmission electrode being an open end,
wherein the particular second transmission electrode has one end and another end to extend slenderly from the one end thereof to the another end thereof in the direction opposite to the second direction, the one end of the particular second transmission electrode being connected to a particular second wiring among the plurality of second wirings, the another end of the particular second transmission electrode being an open end, and
wherein the any first transmission electrode and the particular second transmission electrode are driven simultaneously by a particular signal and a further particular signal that are input through the particular first wiring and the particular second wiring, respectively.

12. The touch panel of claim 11, wherein the particular signal is identical to the further particular signal.

13. The touch panel of claim 7, wherein the plurality of first transmission electrodes and the plurality of second transmission electrodes have shapes substantially identical to each other, and are made of materials identical to each other.

14. The touch panel of claim 7, further comprising one or more receiving electrodes facing the plurality of first transmission electrodes and the plurality of second transmission electrodes in a third direction crossing the first direction and the second direction such that the one or more receiving electrodes are spaced from the plurality of first transmission electrodes and the plurality of second transmission electrodes.

15. The touch panel of claim 14, wherein the one or more receiving electrodes are arranged in the second direction, and substantially have a strip shape extending slenderly in the first direction.

16. The touch panel of claim 14, wherein the one or more receiving electrodes comprise a plurality of receiving electrodes.

17. A touch panel device comprising:
the touch panel of claim 7; and
a controller that supplies the first signal and the second signal to the touch panel.

18. A touch panel device comprising:
the touch panel of claim 11; and
a controller that supplies the first signal, the second signal, the particular signal, and the further particular signal to the touch panel.

19. A touch panel comprising:
a plurality of lateral electrodes arranged in a first direction and having strip shapes extending slenderly in a second direction crossing the first direction; and
a plurality of wirings each connected to respective one of the plurality of lateral electrodes,
wherein the plurality of lateral electrodes include a first lateral electrode and a second lateral electrode that are adjacent to each other in the first direction, and
wherein the plurality of wirings include a first wiring connected to the first lateral electrode and a second wiring connected to the second lateral electrode,
wherein the first lateral electrode has one end and another end to extend slenderly from the one end thereof to the another end thereof in the second direction, the one end of the first lateral electrode being connected to the first wiring, the another end of the first lateral electrode being an open end,
wherein the second lateral electrode has one end and another end to extend slenderly from the one end thereof to the another end thereof in a direction opposite to the second direction, the one end of the second lateral electrode being connected to the second wiring, the another end of the second lateral electrode being an open end, and
wherein the touch panel detects a first signal and a second signal that are obtained simultaneously from the first lateral electrode and the second lateral electrode through the first wiring and the second wiring, respectively.
